(19) United States
(12) Patent Application Publication
(10) Pub. No.: US 2011/0125873 A1
(43) Pub. Date: May 26, 2011

(54) SYSTEM AND METHOD FOR PROVIDING SENSOR OVERLAY NETWORKS

(75) Inventors: Dante J. Pacella, Charles Town, WV (US); Norman Richard Solis, Fairfax, VA (US); Harold Jason Schiller, Silver Spring, MD (US)

(73) Assignee: VERIZON PATENT AND LICENSING, INC., Basking Ridge, NJ (US)

(21) Appl. No.: 12/624,494

(22) Filed: Nov. 24, 2009

(51) Int. Cl. G06F 15/16

(52) U.S. Cl. 709/219

(57) ABSTRACT

A system and method for providing a sensor overlay network is disclosed. The system may comprise a control module configured to receive and respond to data requests; a forwarding module configured to receive a data request from at least one network element and forward a response to the data request to the at least one network element, wherein the data request is directed to a control module; and a sensor module, communicatively coupled to the forwarding module and control module, configured to emulate the control module by receiving and responding to the data request from the forwarding module and handle data traffic received from the forwarding module.

### BACKGROUND INFORMATION

Communications services, such as Internet, telephone, and television services, are becoming increasingly popular among consumers, businesses, and other subscribers. Networks form the basis for such communications services. Some networks provide instrumentation of the network to customers. This gives customers the ability to troubleshoot network-related problems but poses a great security risk since customers are able to locate and identify network components. Furthermore, these networks generally do not have a way to deal with high traffic volume from user-generated packets or signals without new equipment or aggressive filtering techniques. Other networks seek to provide protection against hackers and other security offenses by hiding network topology from customers. However, these networks lack the ability to allow customer troubleshooting. Therefore, as communications services reach more and more customers, it may be important to provide a system and method for providing a sensor overlay network that comprehensively and effectively allows customers the ability to troubleshoot or perform other network functions without sacrificing security, as well as efficiently manage high user-generated traffic.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIG. 1 depicts a block diagram of a system architecture for providing a sensor overlay network, according to an exemplary embodiment.

FIGS. 2A-2B depict schematic diagrams of a sensor plane architecture, according to an exemplary embodiment.

FIG. 3 depicts an illustrative flowchart of a method for providing a sensor overlay network, according to an exemplary embodiment.

FIG. 4 depicts an illustrative flowchart of a method for providing a sensor overlay network, according to another exemplary embodiment.

### DETAILED DESCRIPTION OF EMBODIMENTS

Reference will now be made in detail to exemplary embodiments, examples of which are illustrated in the accompanying drawings. It should be appreciated that the same reference numbers will be used throughout the drawings to refer to the same or like parts. It should be appreciated that the following detailed description are exemplary and explanatory only and are not restrictive.

Exemplary embodiments may provide a system and method for providing a sensor overlay network. That is, exemplary embodiments may, among other things, manage and optimize user-generated packet traffic and troubleshooting by comprehensively and effectively providing a sensor overlay network.

Networks form the basis for communications services, such as Internet, telephone, and television services. “Open” networks may allow a user or customer to view instrumentation of the network. In an open network, user-generated packets for troubleshooting may be received by all devices in the network, each of which may reply to these user-generated packets. This allows customers the ability to troubleshoot network-related problems or determine whether enough local system resources are available. However, such openness may pose a great security risk since customers are able to locate and identify each and every network component.

Larger networks may be more complex. For example, in larger networks, traceroutes of fifteen (15) or more router hops may result from user-generated packets. In an open network, all hops may be visible to the end-user. Because the network is open, an end-user or customer may not be limited by the volume of user-generated packets sent to gain insight into the performance, design, or connectivity of the network. As a result, all network components (e.g., routers) within the network may be impacted with excessive amounts of user-generated forwarding plane measurement traffic. Thus, any insight gained by a user during such high traffic conditions may be distorted by the low priority of this measurement traffic on a central processing unit (“CPU”) of a network component (e.g., router). Accordingly, while an open network provides a user-friendly network model, security and efficient traffic controls may be lacking. Moreover, end-users or customers who measure network performance using these instrumented packets may have a relatively skewed view or perception of network performance due to variance in measurement traffic of an open network.

“Closed” networks may provide greater protection from user-generated, infrastructure-target packets by hiding topology from end-users or customers. A closed network may create what appears to be a “black box” to end-users and customers. These black boxes may still allow a customer to interface with the network (e.g., the network components may still respond to user-generated packets), but nothing inside the network may be visible to the customer. It should be appreciated that allowing any access may nevertheless still publicly expose systems and components of a network.

In addition, even though security may be improved with closed networks, problems associated with efficient traffic control may still be present. Furthermore, a customer may have difficulty troubleshooting issues occurring locally, off-net, or with his or her provider's network in a closed architecture. Not having data associated with infrastructure may result in costly support calls or other inefficiencies. In addition, lack of network visibility may also prevent a customer's ability to independently verify performance service level agreements, which may result in lack of trust in the integrity of the network.

As a result, it may be important to provide a system and method for providing a sensor overlay network to comprehensively and effectively allow customers the ability to troubleshoot or perform other network functions in a secure and traffic-efficient environment.

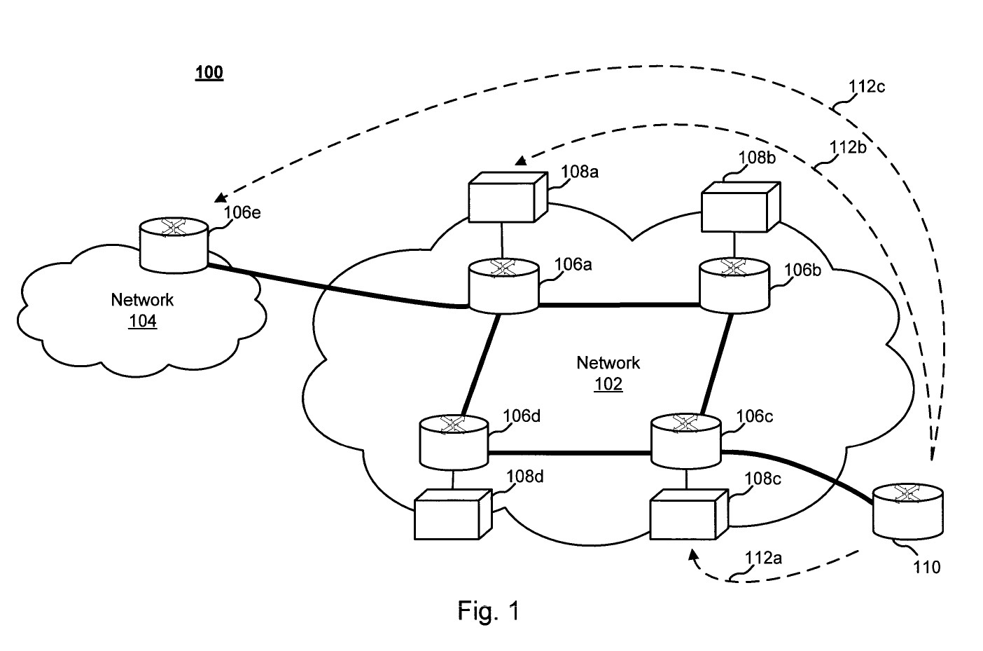

FIG. 1 depicts a block diagram of a system architecture for providing a sensor overlay network 100, according to an exemplary embodiment. As illustrated, the system 100 may include a first network 102. The first network 102 may be a local network, a service provider network, or other network. In some embodiments, the first network 102 may be communicatively coupled to a second network 104. The second network 102 may be an off-net network or other similar network. The first network 102 may include network elements 106a, 106b, 106c, and 106d, which may be communicatively coupled with one another. Network elements 106a, 106b, 106c, and 106d may also be communicatively coupled to other components, such as network element 106e (e.g., in the second network 104) or end-user or customer-side network element 110. In some embodiments, network elements 106a, 106b, 106c, and 106d may each be communicatively coupled to network boxes 108a, 108b, 108c, and 108d, respectively. These network boxes 108a, 108b, 108c, and 108d may be used to form a sensor overlay network. Traceroutes 112a, 112b, and 112c may be used to provide measurement traffic from the end-user or customer-side network element 110 to a network component residing at the network or other location. Other devices or network components (e.g., intermediary network components) may be communicatively coupled with the first network 102, the second network 104, or the end-user or customer-side network element 110.

Network 102 or network 104 may be a wireless network, a wired network, or any combination of wireless network and wired network. For example, network 102 or network 104 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11g or any other wired or wireless network for transmitting or receiving a data signal. In addition, network 102 or network 104 may include, without limitation, telephone line, fiber optics, IEEE Ethernet 802.3, a wide area network (“WAN”), a local area network (“LAN”), or a global network such as the Internet. Also, network 102 or network 104 may support, an Internet network, a wireless communication network, a cellular network, or the like, or any combination thereof. Network 102 or network 104 may further include one, or any number of the exemplary types of networks mentioned above operating as a stand-alone network or in cooperation with each other. Network 102 or network 104 may utilize one or more protocols of one or more network elements to which it is communicatively coupled. Network 102 or network 104 may translate to or from other protocols to one or more protocols of network devices.

Although network 102 or network 104 is depicted as one network, it should be appreciated that according to one or more embodiments, network 102 or network 104 may comprise a plurality of interconnected networks, such as, for example, service provider network, the Internets, a broadcasting networks, cable television networks, corporate networks, or home networks.

Network elements 106a, 106b, 106c, 106d, and 106e may transmit and receive data to and from network 102 or network 104 representing broadcast content, user request content, mobile communications data, or other data. The data may be transmitted and received utilizing a standard telecommunications protocol or a standard networking protocol. For example, one embodiment may utilize Session Initiation Protocol (“SIP”). In other embodiments, the data may be transmitted or received utilizing other Voice Over IP (“VOIP”) or messaging protocols. For example, data may also be transmitted or received using Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet (“TCP/IP”) Protocols, or other protocols and systems suitable for transmitting and receiving data. Data may be transmitted and received wirelessly or may utilize cabled network or telecom connections such as an Ethernet RJ45/Category 5 Ethernet connection, a fiber connection, a traditional phone wireline connection, a cable connection or other wired network connection. Network 102 network 104 may use standard wireless protocols including IEEE 802.11a, 802.11b and 802.11g. Network 102 network 104 may also use protocols for a wired connection, such as an IEEE Ethernet 802.3.

In some embodiments, network elements 106a, 106b, 106c, 106d, and 106e may be provider-owned routers used to forward customer data. These routers may run various routing protocols between them to communicate reachability information.

Other network elements (e.g., intermediary devices) may be included in or near network 102 and network 104. An intermediary device may include a repeater, microwave antenna, amplifier, cellular tower, or another network access device capable of providing connectivity between to different network mediums. These intermediary devices may be capable of sending or receiving signals via a mobile network, a paging network, a cellular network, a satellite network or a radio network. These network elements may provide connectivity to one or more wired networks and may be capable of receiving signals on one medium such as a wired network and transmitting the received signals on a second medium, such as a wireless network.

Network boxes 108a, 108b, 108c, and 108d may include dedicated machinery (e.g., sensor CPUs) for providing an sensor overlay network at network 102. For example, network boxes 108a, 108b, 108c, and 108d may be out-of-band sensor CPUs and may be communicatively coupled to network elements 106a, 106b, 106c, and 106d, as depicted in FIG. 1. Network boxes 108a, 108b, 108c, and 108d may be dedicated to respond to user-generated measurement traffic. These boxes may be separate hardware that collocated and connected to the network routers or these boxes may be integrated into the hardware of the network routers in such a way that the measurement traffic does not impede or is impacted by other control plane traffic or customer data traffic. The sensor CPUs may therefore provide a more accurate view of the network.

The network boxes 108a, 108b, 108c, and 108d may emulate network elements and respond to queries from end-user or customer-side network element 110. Network boxes 108a, 108b, 108c, and 108d may use a variety of overlay mechanisms. These may include, but not limited to, Generic Routing Encapsulation (“GRE”) tunnels, Internet Protocol Security (“IPSec”) tunnels, Internet Protocol to Internet Protocol (“IP-IP”) tunneling, Reservation Protocol or Resource Reservation Protocol (“RSVP”) or Label Distribution Protocol (“LDP”) signaled Multiprotocol Label Switching (“MPLS”) Label Switch Paths (“LSPs”).

Network elements 106a, 106b, 106c, 106d, and 106e and network boxes 108a, 108b, 108c, and 108d may be one or more servers (or server-like devices), such as a Session Initiation Protocol (“SIP”) server. Network elements 106a, 106b, 106c, 106d, and 106e and network boxes 108a, 108b, 108c, and 108d may include one or more processors (not shown) for transmitting, receiving, processing, or storing data. According to one or more embodiments, network elements 106a, 106b, 106c, 106d, and 106e may be servers providing network service and network boxes 108a, 108b, 108c, and 108d may emulate their respective network elements to provide a sensor overlay network. In other embodiments, network elements 106a, 106b, 106c, 106d, and 106e and network boxes 108a, 108b, 108c, and 108d may be servers that provide network connection, such as the Internet, public broadcast data, a cable television network, or another media.

It should be appreciated that each of the components of system 100 may include one or more processors for recording, transmitting, receiving, or storing data. Although each of the components of system 100 are depicted as individual elements, it should be appreciated that the components of system 100 may be combined into fewer or greater numbers of devices and may be connected to additional devices not depicted in FIG. 1. For example, in some embodiments, network boxes 108a, 108b, 108c, and 108d may be integrated within network elements 106a, 106b, 106c, and 106d. Furthermore, each of the components of system 100 may be local, remote, or a combination thereof to one another.

Data storage may also be provided to each of the components of system 100. Data storage may be network accessible storage and may be local, remote, or a combination thereof to the components of system 100. Data storage may utilize a redundant array of inexpensive disks (“RAID”), tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), or other computer accessible storage. In one or more embodiments, data storage may be a database, such as an Oracle database, a Microsoft SQL Server database, a DB2 database, a MySQL database, a Sybase database, an object oriented database, a hierarchical database, or other database. Data storage 108 may utilize flat file structures for storage of data. It should also be appreciated that network-based or GPS-based timing (e.g., Network Time Protocol (“NTP”)) between the measurement boxes for synchronization may be provided as well. Other various embodiments may also be realized.

The end-user or customer-side network element 110 may be another network, a residential gateway, such as a router, an optical network terminal, or a piece of Customer Premises Equipment (“CPE”) providing access to one or more other equipment. For example, in some embodiments, the end-user or customer-side network element 110 element 110 may be another network that provides connectivity to a service provider at network 102 or network 104.

The end-user or customer-side network element 110 may be, or may be communicatively coupled to, a desktop computer, a laptop computer, a server, a server-like device, a mobile communications device, a wireline phone, a cellular phone, a mobile phone, a satellite phone, a personal digital assistant (“PDA”), a computer, a handheld MP3 player, a handheld multimedia device, a personal media player, a gaming device, or other devices capable of communicating with network 102 or network 104 (e.g., CPE, television, radio, phone, or appliance). The end-user or customer-side network element 110 may include wired or wireless connectivity. User-generated, infrastructure-targeted packets may originate from the end-user or customer-side network element 110. For example, basic performance measurements may rely on Internet Control Message Protocol (“ICMP”) ping, ICMP traceroute, User Datagram Protocol (“UDP”) traceroute, or other protocol.

System 100 may be used for communications between two or more components of the system 100. System 100 may also be used for transmitting or receiving data associated with a variety of content, such multimedia content. The various components of system 100 as shown in FIG. 1 may be further duplicated, combined, or integrated to support various applications and platforms. Additional elements may also be implemented in the systems described above to support various applications.

Referring to FIG. 1, an end-user or customer-side network element 110 may rely one or more traceroutes to identify or determine measurement traffic at a network element. For example, a customer traceroute 112a from the end-user or customer network element 110 may seek to identify measurement traffic network element 106c and a customer traceroute 112b from the end-user or customer network element 110 may seek to identify measurement traffic network element 106a. In this example, because each of the network elements 106a and 106c are associated with network box 108a and 108c, respectively, traceroute 112a may be shunted to network box 108c and traceroute 112b may be shunted to network box 108a. Unbeknownst to the end-user or customer-side network element 110, these network boxes may respond on behalf of their respective network elements. Traceroute 112c may provide traffic to network element 106e of the second network 104.

By providing one or more network boxes, an out-of-band sensor network may be provided at network 102. This overlay may be separate from any other overlay networks that may exist in a providers domain, e.g., network 104. A sensor overlay network may therefore provide an excellent solution where the network remains closed and protected while allowing the end-users to ascertain useful performance and connectivity information about the network. In fact, the information provided may be more accurate when compared to the open network because of the dedicated sensors and the separation of the traffic. Further refinements may be available in that the hardware of the network boxes 108a, 108b, 108c, and 108d (e.g., sensor CPUs) may be customized and optimized to respond to various sensor traffic. Additionally, the network elements 106a, 106b, 106c, and 106d be configured in a way that they may not be required to respond to sensor traffic.

In the out-of-band sensor network or sensor overlay network, dedicated paths for user-generated sensor packets may be provided to mitigate issues associated with hidden network topology. Furthermore, the sensor network may experience higher infrastructure security since network instrumentation or internal network elements may be walled off from customer reachability. Furthermore, with the exception of traffic that is required for routing, other traffic destined to network elements 106a, 106b, 106c, and 106d may be shunted to the sensor overlay network at the first network 102. Not only does this eliminate or reduce load on the network elements 106a, 106b, 106c, and 106d, use of network boxes 108a, 108b, 108c, and 108d also removes attack vectors and allows the overlay sensor network to provide a more accurate monitoring of the network itself.

In some embodiments, network boxes 108a, 108b, 108c, and 108d (e.g., sensor CPUs) may be leveraged as a platform to source diagnostic traffic from without jeopardizing health or security of the network. End-user greater visibility and more targeted information for troubleshooting may be provided as a result. Increased visibility may also increase customer comfort with network performance and reduce expensive customer service calls and other disadvantages.

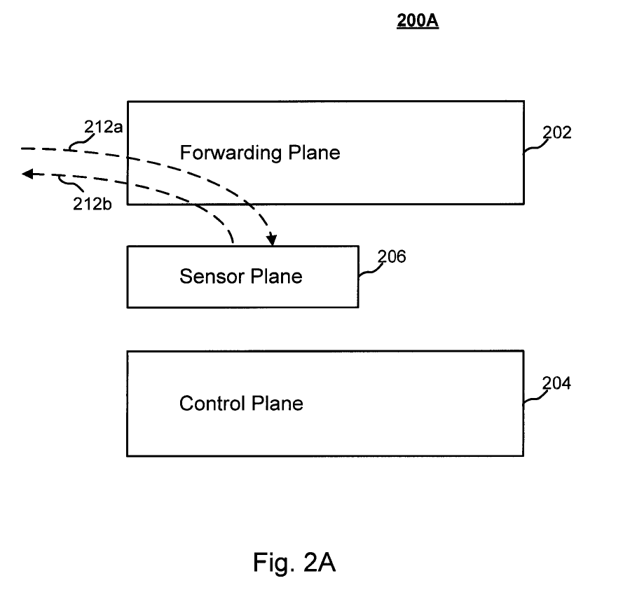

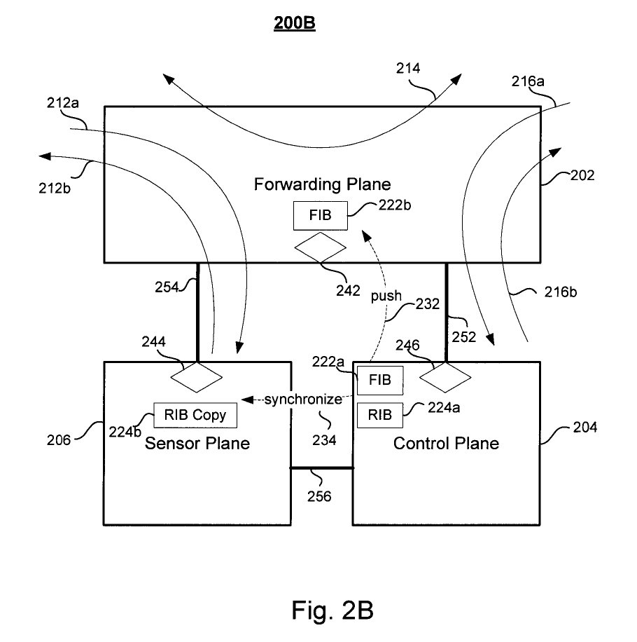

FIG. 2A depicts schematic diagram of a sensor plane architecture 200A, according to an exemplary embodiment. In some embodiments, the sensor plane architecture 200 may be included in network boxes 108a, 108b, 108c, and 108d for providing a sensor overlay network. In other embodiments, the sensor plane architecture 200 may be included in network elements 106a, 106b, 106c, and 106d without separate network boxes 108a, 108b, 108c, and 108d.

The sensor plane architecture 200 may include a forwarding plane 202 that forwards data 212a (e.g., an ICMP request) to the control plane 204. It should be appreciated that routing protocols may typically be communicated between the control plane of one network element to another. However, in a sensor overlay network, the control plane 204 may be shielded from such activity when a sensor plane 206 is provided. When a sensor plane 206 is used, the data 212a is forwarded to the sensor plane 206 instead of the control plane 204. In this example, the sensor plane 206 may emulate the control plane 204 and respond with response data 212b (e.g., an ICMP reply) via the forwarding plane 202.

In addition, the sensor plane 206 may obtain routing/forwarding information from the control plane 204 and recreate a representative network based on routing protocol information. In other words, using the sensor plane architecture 200, a network emulation layer may build a virtual topology that mimics the actual network. Accordingly, the network emulation layer of each of the network elements 106a, 106b, 106c, and 106d or network boxes 108a, 108b, 108c, and 108d may be connected with a tunnel overlay that is transparent to the sensor plane 206 and the network emulation layer. Here, the overlay tunnels may be constructed to appear as physical circuits to the sensor plane.

Various filtering may allow the sensor plane 206 to shunt traffic from the control plane 204. For example, separate and distinct instances of the control plane 204 may be created so that the sensor plane 206 may function within the routing platform identically or similarly as the control plane 204 would function.

This additional level of separation may enable end-users to exchange routing protocol information with this sensor plane CPU further reducing attacks on the routing infrastructure. Use of a sensor layer network may also mitigate control plane attacks, including well-crafted packet attacks, since the control plane 204 may be completely isolated to external routing communications.

A higher level of security to segments of end-users or communities of interest by separating them across sets of sensor plane CPUs may also be provided. For example, a small number of highly critical customers may share a sensor plane CPU while a majority of less critical customers and peers may be aggregated on other sensor CPUs. Such security segmentation may further reduce routing attacks between communities of interest or segments of customers (e.g., from the majority of customers or peers to those few highly critical customers).

FIG. 2B depicts schematic diagram of a sensor plane architecture 200B, according to another exemplary embodiment. In this example, the sensor plane architecture 200B may be similar to the sensor plane architecture 200A of FIG. 2A. For instance, the sensor plane architecture 200B may include a forwarding plane 202, a control plane 204, and a sensor plane 206.

In this example, routing traffic 216a and 216b may traverse the forwarding plane 202 to or from the control plane 204 and sensor traffic 212a and 212b may traverse the forwarding plane 202 to or from the sensor plane 206.

In some embodiments, decision engines 242, 244, and 246 may be provided in the forwarding plane 202, the control plane 204, or the sensor plane 206, respectively. These decision engines 242, 244, and 246 may determine how to handle various types of traffic at each of the forwarding plane 202, the control plane 204, or the sensor plane 206. For example, the forwarding plane decision engine 242 may determine whether or not traffic is transiting traffic 214, routing traffic 216a and 216b, or sensor traffic 212a and 212b. In the case of transiting traffic 214, the forwarding plane decision engine 242 may keep the traffic on the forwarding plane 202 and traverses the device 200B. In the case of routing traffic 216a and 216b, the forwarding plane decision engine 242 may deliver the traffic to or from the control plane. In the case of sensor traffic 212a and 212b, the forwarding plane decision engine 242 may deliver the traffic to or from the sensor plane 206. It should be appreciated that the forwarding plane decision engine 242 may perform other various functions optionally filter, rate limit, log, syslog, or forward to the control plane any or all sensor traffic 212a and 212b that meets one or more profiles, such as a five-tuple criteria. Although described with reference to the forwarding plane decision engine 242, it should be appreciated that the above features and functions may be implemented in one or more additional decision engines as well (e.g., decision engines 244 and 246).

Through routing traffic, the control plane 204 may acquire information from itself and the other network components to form a Routing Information Base (“RIB”) 224a that may has path information. The control plane 204 may optionally synchronize the RIB 224a with the sensor plane 206 to form a RIB copy 224b, for example, thus enabling the sensor plane 206 to simulate forwarding and routing behavior of the control plane 204. Accordingly, any atomic update to the RIB 224a may result in synchronization with the RIB copy 224b.

The control plane 204 may also use the RIB 224a to select Forwarding Information Base (“FIB”) 222a on the control plane 204. The FIB 222a may be pushed 232 (or otherwise transmitted) to other instances of the forwarding plane 202. This may create a local FIB 222b, 222c . . . 222n, as necessary, for each instantiation of the forwarding plane 202.

One or more connections 252 may exist between the forwarding plane 202 and control plane 204. These one or more connections 252 may facilitate communications for routing traffic 216a and 216b, FIB push 232, or other related feature or functionality.

One or more connections 254 may exist between the forwarding plane 202 and the sensor plane 206 to facilitate communications of sensor traffic 212a and 212b. One or more connections 256 may exist between the control plane 204 and the sensor plane 206 to facilitate communications for RIB synchronization 234. Other various embodiments may also be provided to facilitate communications, synchronization, or other related features or functionalities.

It should be appreciated that the sensor plane architecture 200A of FIG. 2A and the sensor plane architecture 200B of FIG. 2B may be implemented in a variety of ways. The architectures 200A and 200B may be implemented as a hardware component (e.g., as a module) within a network element or network box. It should also be appreciated that the architecture 200 may be implemented in computer executable software. Although depicted as a single architecture, module functionality of the architectures 200A and 200B may be located on a single device or distributed across a plurality of devices including one or more centralized servers and one or more pieces of customer premises equipment or end user devices.

It should be appreciated that while embodiments are primarily directed to user-generated packets, other data may also be handled by the components of system 100. While depicted as various servers, components, elements, or devices, it should be appreciated that embodiments may be constructed in software or hardware, as a separate or stand-alone device, or as part of an integrated transmission or switching device.

Additionally, it should also be appreciated that system support and updating the various components of the system 100 may be easily achieved. For example, a system administrator may have access to one or more of the components of the system, network, components, elements, or device. It should also be appreciated that the one or more servers, components, elements, or devices of the system may not be limited to physical components. These components may be software-based, virtual, etc. Moreover, the various servers, components, elements, or devices may be customized to perform one or more additional features and functionalities. Such features and functionalities may be provided via deployment, transmitting or installing software or hardware.

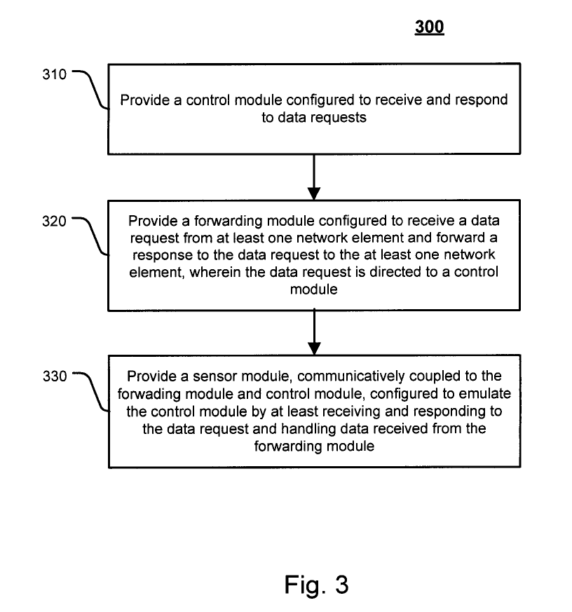

FIG. 3 depicts an illustrative flowchart of a method for providing a sensor overlay network, according to an exemplary embodiment. The exemplary method 300 is provided by way of example, as there are a variety of ways to carry out methods disclosed herein. The method 300 shown in FIG. 3 may be executed or otherwise performed by one or a combination of various systems. The method 300 is described below as carried out by at least system 100 in FIG. 1 and architectures 200A-200B in FIG. 2A-2B, by way of example, and various elements of systems 100 and 200A-200B are referenced in explaining the exemplary method of FIG. 3. Each block shown in FIG. 3 represents one or more processes, methods, or subroutines carried in the exemplary method 300. A computer readable medium comprising code to perform the acts of the method 300 may also be provided. Referring to FIG. 3, the exemplary method 300 may begin at block 310.

At block 310, the control module 204 of FIG. 2A may be provided and configured to receive and respond to data requests. The data request may be a request for basic performance measurements. The data request may be at least one of an Internet Control Message Protocol (“ICMP”) message and User Datagram Protocol (“UDP”) message.

At block 320, the forwarding module 202 of FIG. 2A may be provided and configured to receive a data request from at least one network element and forward a response to the data request to the at least one network element. The data request may be directed to a control module for handling. The network element may be a provider-side network element or a customer-side network element. The network element may be a router, a customer premises equipment (CPE), a server, a gateway, a network terminal, a computer processor, or a network.

At block 330, the sensor module 206 of FIG. 2A may be provided and communicatively coupled to the forwarding module and control module. The sensor module 206 may be configured to emulate the control module 204 by receiving and responding to the data request from the forwarding module and handle data received from the forwarding module. The sensor module 206 may be implemented within a dedicated sensor CPU. It should be appreciated that the dedicated sensor CPU may be separate and distinct from the control plane CPU or may be integrated with the control plane CPU. The sensor module may create an out-of-band sensor layer, forming a sensor overlay network, shielding the control plane from identification. The sensor module may include at least one customizable filter configured to filter data away from the control module. It should be appreciated that the customizable filter may be physical or virtual and may determine how data is handled, processed, and directed. In some embodiments, the customizable filter may filter ICMP messages from the control plane to the sensor plane. In this example, all other traffic may be forwarded to the control plane. In other embodiments, the customizable filter may filter all traffic and redirect it to the sensor plane to process and handle.

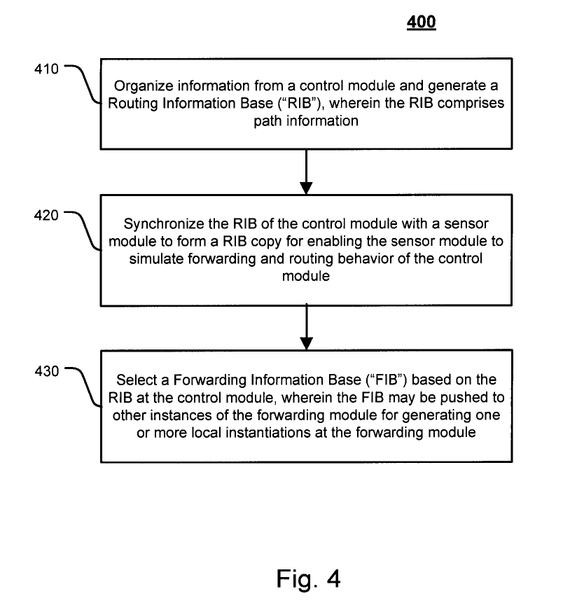

FIG. 4 an illustrative flowchart of a method for providing a sensor overlay network, according to another exemplary embodiment. The exemplary method 400 is provided by way of example, as there are a variety of ways to carry out methods disclosed herein. The method 400 shown in FIG. 4 may be executed or otherwise performed by one or a combination of various systems. The method 400 is described below as carried out by at least system 100 in FIG. 1 and architectures 200A-200B in FIGS. 2A-2B, by way of example, and various elements of systems 100 and 200A-200B are referenced in explaining the exemplary method of FIG. 4. Each block shown in FIG. 4 represents one or more processes, methods, or subroutines carried in the exemplary method 400. A computer readable medium comprising code to perform the acts of the method 400 may also be provided. Referring to FIG. 4, the exemplary method 400 may begin at block 410.

At block 410, the control module 204 of FIG. 2B may organize information from itself and generate a Routing Information Base (“RIB”) 224a. The RIB 224a may comprise path information.

At block 420, the control module 204 may optionally synchronize the RIB 224a with the sensor module 206 to form a RIB copy 224b, for example, thus enabling the sensor module 206 to simulate forwarding and routing behavior of the control module 204. Accordingly, any atomic update to the RIB 224a may result in synchronization with the RIB copy 224b.

At block 430, the control module 204 may use the RIB 224a to select a Forwarding Information Base (“FIB”) 222a on the control module 204. In this example, the FIB 222a may be pushed 232 (or otherwise transmitted) to other instances of the forwarding module 202. This may create a local FIB 222b, 222c . . . 222n, as necessary, for each instantiation of the forwarding module 202.

In summary, embodiments may provide a system and method for providing a sensor overlay network. It should be appreciated that although embodiments are described primarily with basic measurement data and communications between various network components, the systems and methods discussed above are provided as merely exemplary and may have other various applications and implementations.

In the preceding specification, various embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

We claim:

1. A system, comprising:
a control module configured to receive and respond to data requests;
a forwarding module configured to receive a data request from at least one network element and forward a response to the data request to the at least one network element, wherein the data request is directed to a control module; and
a sensor module, communicatively coupled to the forwarding module and control module, configured to emulate the control module by at least receiving and responding to the data request and handling data received from the forwarding module.

2. The system of claim 1, wherein the data request is a request for basic performance measurements.

3. The system of claim 1, wherein the data request comprises at least one of an Internet Control Message Protocol (“ICMP”) message and User Datagram Protocol (“UDP”) message.

4. The system of claim 1, wherein the network element is a provider-side network element.

5. The system of claim 4, wherein the provider-side network element comprises at least one of a router, a server, a gateway, a network terminal, a computer processor, and a network.

6. The system of claim 1, wherein the network element is a customer-side network element.

7. The system of claim 6, wherein the customer-side network element comprising at least one of a router, a customer premises equipment (CPE), a server, a gateway, a network terminal, a computer processor, and a network.

8. The system of claim 1, wherein the sensor module is implemented within a dedicated sensor computer processing unit.

9. The system of claim 1, wherein the sensor module creates an out-of-band sensor layer.

10. The system of claim 1, wherein the sensor module comprising at least one customizable filter configured to filter data away from the control module.

11. A method, comprising:
providing a control module configured to receive and respond to data requests;
providing a forwarding module configured to receive a data request from at least one network element and forward a response to the data request to the at least one network element, wherein the data request is directed to a control module; and
providing a sensor module, communicatively coupled to the forwarding module and control module, configured to emulate the control module by at least receiving and responding to the data request and handling data received from the forwarding module.

12. The method of claim 11, wherein the data request is a request for basic performance measurements.

13. The method of claim 11, wherein the data request comprises at least one of an Internet Control Message Protocol (“ICMP”) message and User Datagram Protocol (“UDP”) message.

14. The method of claim 11, wherein the network element is a provider-side network element.

15. The method of claim 14, wherein the provider-side network element comprises at least one of a router, a server, a gateway, a network terminal, a computer processor, and a network.

16. The method of claim 11, wherein the network element is a customer-side network element.

17. The method of claim 16, wherein the customer-side network element comprising at least one of a router, a customer premises equipment (CPE), a server, a gateway, a network terminal, a computer processor, and a network.

18. The method of claim 11, wherein the sensor module is implemented within a dedicated sensor computer processing unit.

19. The method of claim 11, wherein the sensor module creates an out-of-band sensor layer.

20. The method of claim 11, wherein the sensor module comprising at least one customizable filter configured to filter data away from the control module.

21. A computer readable medium comprising code to perform the acts of the method of claim 11.
